(19) United States
(12) Patent Application Publication
(10) Pub. No.: US 2010/0117721 A1
(43) Pub. Date: May 13, 2010

(54) GENERATOR AND METHOD FOR GENERATING REFERENCE VOLTAGE AND REFERENCE CURRENT

(75) Inventors: Chih-Yuan Hsieh, Hsinchu City (TW); MAUNG MAUNG WIN, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/402,478

(22) Filed: Mar. 11, 2009

(30) Foreign Application Priority Data
Nov. 12, 2008 (TW) 97143744

(51) Int. Cl. G05F 1/10

(52) U.S. Cl. 327/539; 327/538

(57) ABSTRACT

A generator for generating reference voltage and reference current includes a reference voltage generating circuit for generating a first voltage and a second voltage, which are in combination to produce a reference voltage. The first voltage and the second voltage are respectively having a first-direction response variation and a second-direction response variation, according to a temperature variation. A voltage-to-current inverting circuit is coupled to the reference voltage generating circuit for generating a first current, which has the first-direction response variation as the temperature variation, according to the first voltage. An adding circuit is coupled to the reference voltage generating circuit and the voltage-to-current inverting circuit to obtain a second current corresponding to the second voltage from the reference voltage generating circuit. The first current and the second current are added to have a reference current. The second current has the second-direction response variation as the temperature variation.

### CROSS-REFERENCE TO RELATED APPLICATION

This application claims the priority benefit of Taiwan application serial no. 97143744, filed on Nov. 12, 2008. The entirety of the above-mentioned patent application is hereby incorporated by reference herein and made a part of specification.

### BACKGROUND OF THE INVENTION

1. Field of the Invention

The present invention generally relates to a technology for generating a reference voltage and a reference current which are temperature-independent, and more particularly, to a technology for simultaneously generating a reference voltage and a reference current which are substantially temperature-independent.

2. Description of Related Art

Temperature-dependent reference voltages and temperature-dependent currents are often used in integrated circuit (IC) design. These reference voltages and reference currents are often generated by band-gap reference circuits. However, a conventional band-gap reference circuit is incapable of simultaneously generating a voltage and a current which are substantially temperature-independent in a same circuit. Therefore, a band-gap reference circuit for generating a temperature-independent voltage and a band-gap reference circuit for generating a temperature-independent current must be individually provided. Unfortunately, this disadvantageously increases elements employed in the circuit, the area of the circuit, and the power consumption.

Some conventional band-gap reference circuits for generating a temperature-independent voltage are shown in FIGS. 1-3. All of these can be used for generating a temperature-independent voltage. However, the currents provided by these circuits are positive temperature-dependent. As mentioned above, these conventional circuits are incapable of generating a temperature-independent current when generating a temperature-independent voltage.

As shown in FIG. 1, a conventional band-gap reference circuit includes two paths which are symmetric each other. The two paths are constituted by two PMOS transistors 100, 104, and two NMOS transistors 102, 106, respectively. Each of the PMOS transistors 100, 104 has a terminal coupled to a voltage source 108. The NMOS transistor 102 has a terminal coupled to a ground voltage via a bipolar junction transistor (BJT) 110. The NMOS transistor 106 has a terminal coupled to the ground voltage via a resistor R1 and a BJT 112. The BJT 110 has an area of A, and the BJT 112 has an area of nA, and therefore for example a current, V_{T} ln(n)/R1, is generated, in which ln(n) represents a natural logarithm of n. Further, the other path includes a serially connected PMOS 114, a resistor R2, and a BJT 116 having an area of A. As such, the generated current, V_{T} ln(n)/R1, flows by the resistor R2, thus obtaining a voltage difference, (R2/R1)V_{T} ln(n). Further, the V_{BE} of the BJT 116 also produces a voltage difference. Thus, a reference voltage Vref is obtained at an output terminal as defined in equation (1).

Vref=(R2/R1)V_{T} ln(n)+V_{BE} (1)

The voltage difference (R2/R1)V_{T} ln(n) has a positive direction responsive variation according to a temperature variation (positive temperature coefficient), and V_{BE} has a negative direction responsive variation according to the temperature variation (negative temperature coefficient). Therefore, if the circuit is properly designed, affections caused by the positive temperature coefficient and the negative temperature coefficient can be neutralized one by another. In such a way, a temperature-independent voltage Vref can be obtained.

However, although the aforementioned circuit can be used to obtain a temperature-independent reference voltage, the current V_{T} ln(n)/R1 obtained thereby is positively temperature-dependent.

FIG. 1 illustrates a conventional band-gap reference circuit. FIG. 2 illustrates another conventional band-gap reference circuit. As shown in FIG. 2, PMOS transistors 120, 122, 130, and BJTs 126, 128, 132 are similar as shown in FIG. 1. However, the conventional band-gap reference circuit of FIG. 2 employs an operation amplifier 124 for substituting the NMOS transistors 102 and 106 which are used in the conventional band-gap reference circuit of FIG. 1. As shown in FIG. 2, the operation amplifier 124 has a negative terminal coupled to a node 132, and a positive terminal coupled to a node 134. The node 132 is connected with the BJT 126, while the node 134 is connected with the resistor R1 and the BJT 128.

FIG. 3 illustrates still another conventional band-gap reference circuit. Referring to FIG. 3, it can be seen that this conventional band-gap reference circuit is modified in accordance with the conventional band-gap reference circuit of FIG. 2, in that the PMOS transistor 130 and the BJT 132 of FIG. 2 are omitted, and the resistors R2 and R1 are serially connected by the node 134. In such a way, an output of a temperature-independent reference voltage can also be achieved.

Even though all of the band-gap reference circuits illustrated in FIGS. 1 to 3 are be used to obtain a temperature-independent reference voltage, the obtained currents V_{T} ln(n)/R1 are still positively temperature-dependent.

FIG. 4 illustrates a typical one of conventional band-gap reference circuits for generating a temperature-independent reference current. Referring to FIG. 4, it is a modification made in accordance with the circuit as shown in FIG. 3, and is adapted for obtaining a temperature-independent current as defined by equation (2).

Iref=V_{T} ln(n)/R1+V_{BE}/R2 (2)

As shown in FIG. 4, there are two resistors R2 respectively connected between the nodes 132, 134 and the ground voltage. However, the circuit of FIG. 4 is incapable of generating a temperature-independent voltage at the same time. As such, the conventional band-gap reference voltages are incapable of simultaneously generating a temperature-independent voltage and a temperature-independent in a same circuit.

Therefore, it is a considerable concern to develop a band-gap reference voltage for simultaneously generating a reference voltage and a reference current which are temperature-independent, so as to further save the circuit area and the power consumption.

### SUMMARY OF THE INVENTION

Accordingly, the present invention is directed to providing a generator and a method for generating a reference voltage and reference current, for simultaneously generating a reference voltage and a temperature-independent reference voltage and a temperature-independent reference current by only one band-gap reference circuit rather than two.

The present invention provides a generator for generating a reference voltage and a reference current. The generator includes a reference voltage generating circuit for generating a first voltage and a second voltage, and combining the first voltage and the second voltage to obtain a reference voltage. According to a temperature variation, the first voltage and the second voltage have a first direction responsive variation and a second direction responsive variation, respectively. A voltage-to-current converting circuit is coupled to the reference generating circuit, for outputting a first current according to the first voltage. The first current has a first direction responsive variation according to the temperature variation. An adding circuit is coupled to the reference voltage generating circuit and the voltage-to-current converting circuit, for fetching a second current corresponding to the second voltage from the reference voltage generating circuit, and adding the first current to the second current to obtain a reference current. The second current has a second direction responsive variation according to the temperature variation. Both of the reference voltage and the reference current are temperature-independent.

According to an embodiment of the present invention, in the generator for generating a reference voltage and a reference current, the voltage-to-current converting circuit for example further includes a mapping circuit, for mappingly inputting the first current into the adding circuit.

According to an embodiment of the present invention, in the generator for generating a reference voltage and a reference current, the voltage-to-current converting circuit for example further includes a resistor, for converting the first voltage into the first current.

According to an embodiment of the present invention, in the generator for generating a reference voltage and a reference current, for example the first direction responsive variation is a negative responsive variation, and the second responsive variation is a positive responsive variation.

According to an embodiment of the present invention, in the generator for generating a reference voltage and a reference current, for example, the first direction responsive variation is a positive responsive variation, and the second responsive variation is a negative responsive variation.

According to an embodiment of the present invention, in the generator for generating a reference voltage and a reference current, for example the reference voltage generating circuit is a band-gap reference voltage generator.

According to an embodiment of the present invention, in the generator for generating a reference voltage and a reference current, for example, the voltage-to-current converting circuit fetches the first voltage from the band-gap reference voltage generator, and the adding circuit fetches the second current corresponding to the second voltage from the band-gap reference voltage generator.

According to an embodiment of the present invention, in the generator for generating a reference voltage and a reference current, the reference voltage is a sum of the first voltage and the second voltage.

The present invention further provides a method for generating a reference voltage and a reference current. The method includes generating a first voltage and a second voltage with a voltage generating circuit. According to a temperature variation, the first voltage and the second voltage have a first direction responsive variation and a second direction responsive variation, respectively. Then, a reference voltage is generated according to the first voltage and the second voltage. The first voltage is converted for outputting a first current. The first current has a first direction responsive variation according to the temperature variation. A second current corresponding to the second voltage is obtained. The second current has a second direction responsive variation according to the temperature variation. The first current and the second current are added to obtain a reference current. Both of the reference voltage and the reference current are temperature-independent.

According to an embodiment of the present invention, in the method for generating a reference voltage and a reference current, for example the first direction responsive variation is a negative responsive variation, and the second responsive variation is a positive responsive variation.

According to an embodiment of the present invention, in the method for generating a reference voltage and a reference current, for example, the first direction responsive variation is a positive responsive variation, and the second responsive variation is a negative responsive variation.

According to an embodiment of the present invention, in the method for generating a reference voltage and a reference current, for example the reference voltage generating circuit is a band-gap reference voltage generator.

According to an embodiment of the present invention, in the method for generating a reference voltage and a reference current, for example, the first voltage is fetched from the band-gap reference voltage generator, and the second current corresponding to the second voltage is fetched from the band-gap reference voltage generator.

According to an embodiment of the present invention, in the method for generating a reference voltage and a reference current, the reference voltage is a sum of the first voltage and the second voltage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1-3 are schematic diagrams illustrating conventional band-gap reference circuits for generating a temperature-independent voltage.

FIG. 4 is a schematic diagram illustrating a conventional band-gap reference circuit for generating a temperature-independent current.

FIG. 5 is a schematic circuit block diagram for illustrating an embodiment of the present invention for simultaneously generating a reference voltage and a reference current.

FIGS. 6-8 are schematic circuit architectural diagram illustrating embodiments of the present invention for simultaneously generating a reference voltage and a reference current.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention employs a current temperature coefficient eliminating mechanism into a conventional band-gap reference circuit, so as to simultaneously eliminate the positive temperature coefficients and the negative temperature coefficients of the voltage and the current in the reference circuit. In such a way, the band-gap reference circuit can simultaneously generate a temperature-independent current when generating a temperature-independent voltage, thus saving the production cost and the power consumption.

The present invention provides a band-gap reference circuit for simultaneously generating a voltage and a current, which are temperature-independent. Embodiments are to be illustrated hereby for better understanding of the spirit of the present invention. However, it should be noted that the embodiments should not be construed for the purpose of the restricting the scope of the present invention. The embodiments can be modified or combined one by another or one according to another.

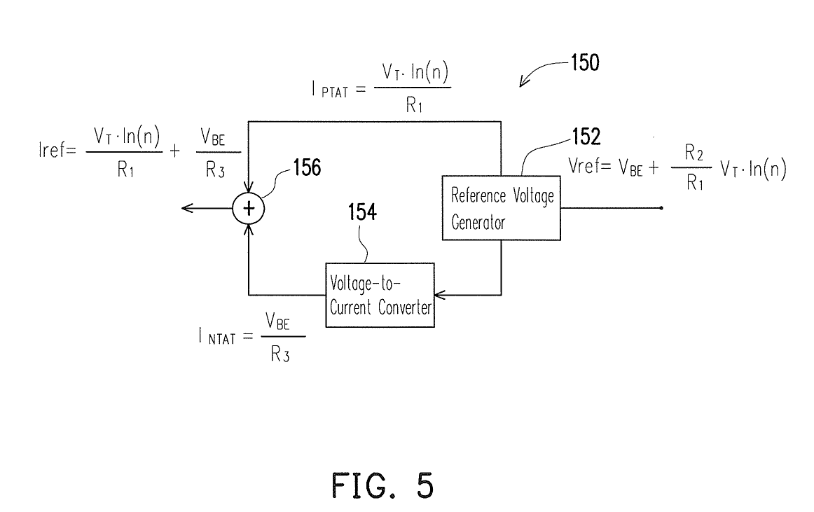

FIG. 5 is a schematic circuit block diagram for illustrating an embodiment of the present invention for simultaneously generating a reference voltage and a reference current. Referring to FIG. 5, a generator 150 is for simultaneously generating a reference voltage and a reference current. The generator 150 essentially includes three blocks, e.g., a reference voltage generator 152, a voltage-to-current converter 154, and an adding unit 156.

The reference voltage generator 152 is adapted for generating the reference voltage and the reference current. The reference voltage generator 152 for example can be a conventional band-gap circuit, which is adapted for generating a temperature-independent reference voltage. The reference voltage generator 152 for example is adapted for generating a first voltage and a second voltage. The first voltage and the second voltage can be combined together to obtain the reference voltage. For example, the reference voltage Vref of equation (1) includes a voltage V_{BE}, and another voltage (R2/R1)/V_{T} ln(n). The two voltages V_{BE}, and (R2/R1)/V_{T} ln(n) have a first direction responsive variation and a second direction responsive variation according to a temperature variation, respectively. The reference voltage for example is obtained by adding these two voltages V_{BE}, and (R2/R1)/V_{T} ln(n). In this embodiment, V_{BE} is a negative direction responsive variation, and (R2/R1)/V_{T} ln(n) is a positive direction responsive variation. Therefore, if parameters of the circuit are properly designed, affections caused by the positive temperature coefficient and the negative temperature coefficient can be neutralized one by another. As such, a voltage Vref which is substantially temperature-independent can be obtained.

The voltage-to-current converter 154 receives the voltage V_{BE}, and converts the voltage V_{BE} to output a current. For example, the voltage V_{BE} is converted by employing a resistor R3 to obtain a current, I_{NTAT}=V_{BE}/R3. The current , I_{NTAT}=V_{BE}/R3, has a negative responsive variation according to a temperature variation. The adding circuit 156 fetches a current V_{T} ln(n)/R1 corresponding to the voltage (R2/R1)/V_{T} ln(n) from the reference voltage generator 152. The current V_{T} ln(n)/R1 has a positive responsive variation according to the temperature variation. The adding circuit 156 adds the first current to the second current to obtain a reference current Iref. The reference current Iref is substantially temperature-independent. The reference current Iref can be represented by equation (3).

Iref=V_{T} ln(n)/R1+V_{BE}/R3 (3)

These two currents, V_{T} ln(n)/R1 and V_{BE}/R3, each has a responsive variation according to the temperature variation, and directions of the responsive variations thereof are opposite one to another. Therefore, if parameters of the circuit are properly designed, affections caused by the positive temperature coefficient and the negative temperature coefficient can be neutralized one by another. As such, a current Iref being substantially temperature-independent can be obtained. In such a way, the reference current and the reference voltage, which are temperature-independent, can be simultaneously obtained.

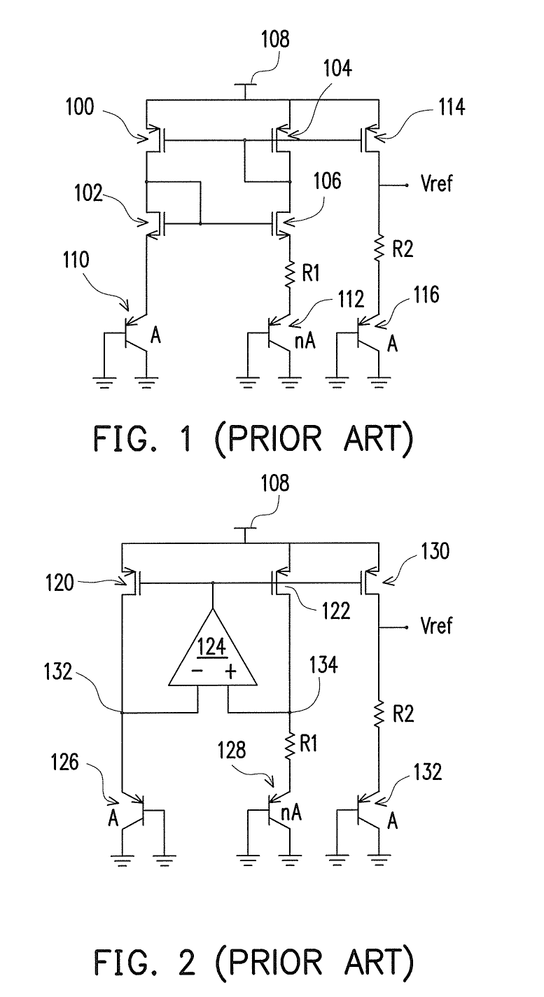

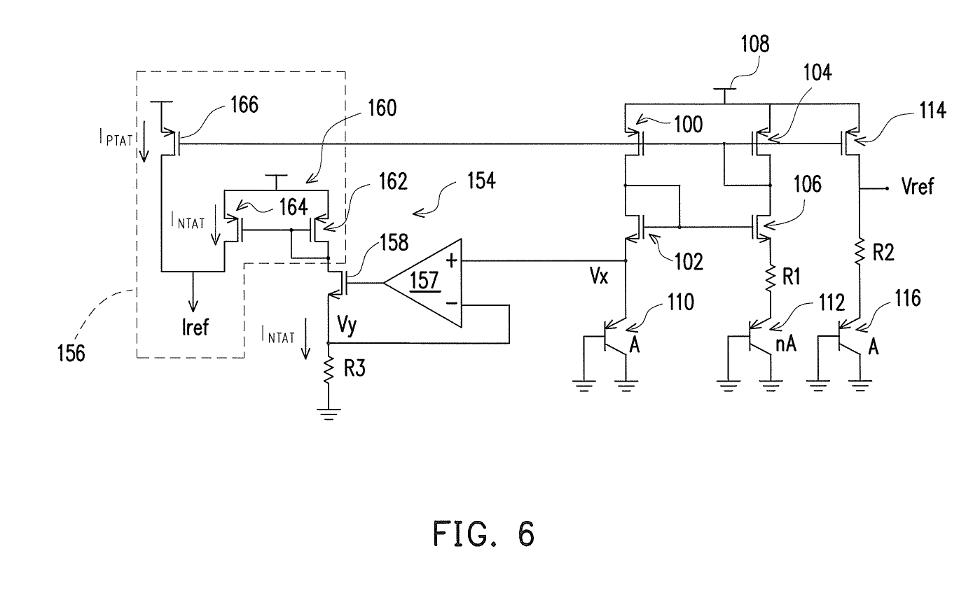

For more details of the circuit, FIGS. 6-8 are schematic circuit architectural diagram illustrating embodiments of the present invention for simultaneously generating a temperature-independent reference voltage and a reference current. Referring to FIG. 6, the current embodiment of the present invention is designed based upon the band-gap reference voltage generator of FIG. 1, which is adapted for providing a desired reference voltage Vref. However, such a conventional band-gap reference voltage generator is incapable of further additionally generating a reference current Iref, which is substantially temperature-independent. In accordance with the architecture of FIG. 5, a part of current, I_{PTAT}=V_{T} ln(n)/R1, is fetched from the band-gap reference voltage generator by a PMOS transistor 166 of the adding unit 156. The current, I_{PTAT}=V_{T} ln(n)/R1, has a positive temperature-dependent characteristic.

Further, the voltage-to-current converting circuit 154 for example includes an operation amplifier 157. The operation amplifier 157 has a positive input terminal (+), a negative input terminal (−), and an output terminal. The positive input terminal receives a voltage, Vx=V_{BE}, corresponding to a BJT 110, from the band-gap reference voltage generator. The negative input terminal (−) is fed back of a voltage Vy and a current I_{NTAT} outputted from the output terminal and via a resistor having a resistance value of R3, in which I_{NTAT}=Vy/R3. The positive input terminal and the negative input terminal of the operation amplifier 157 are connected to a virtual ground. Therefore, Vx=Vy, i.e., Vy=V_{BE} and I_{NTAT}=V_{BE}/R³. The current I_{NTAT} is mapped by a mapping circuit 160 to the adding unit 156, and is added to the current I_{PTAT}. The current I_{NTAT} has a negative temperature-dependent characteristic. As such, temperature effects of the currents I_{PTAT} and I_{NTAT} are neutralized. In such a way, a reference voltage and a reference current which are substantially temperature-independent can be simultaneously obtained by only one band-gap reference voltage generator.

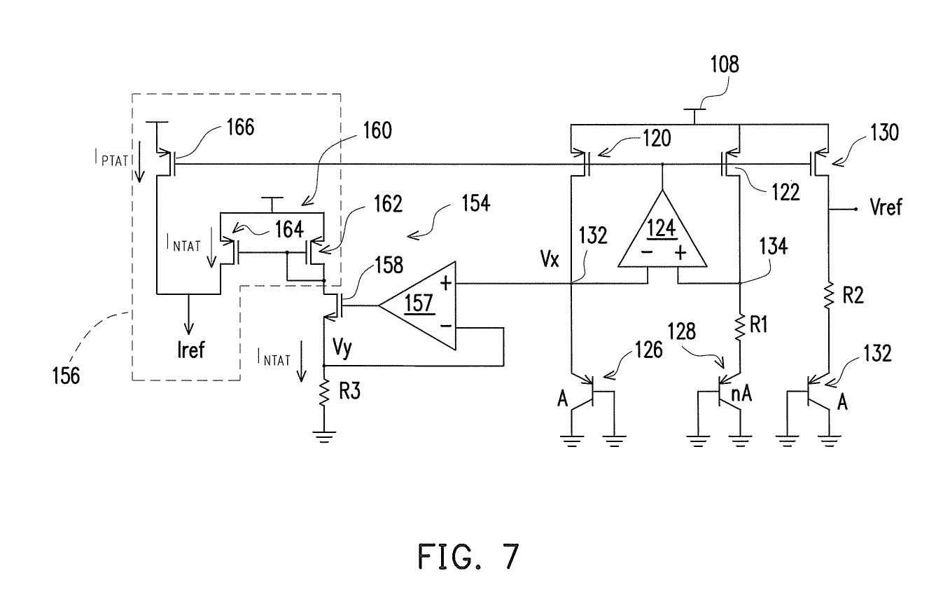

Referring to FIG. 7, the band-gap reference voltage generator of FIG. 2 can also be employed by the present invention for achieving similar objects. As shown in FIG. 7, the positive input terminal (+) of the operation amplifier 157 receives the voltage Vx=V_{BE}, corresponding to the BJT 110, from the band-gap reference voltage generator, while the negative input terminal (−) receives the voltage Vy and the current I_{NTAT} from the output terminal.

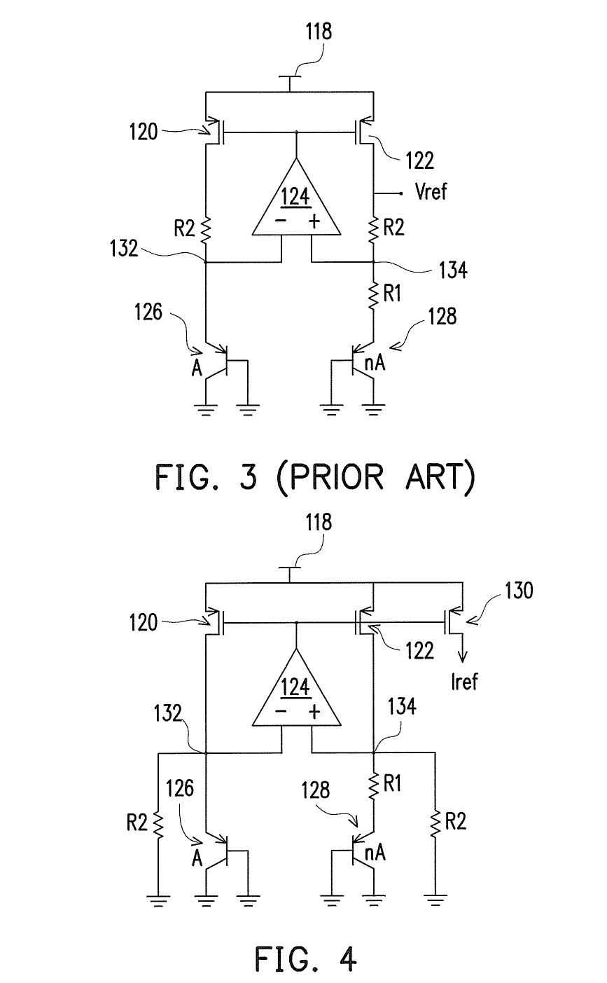

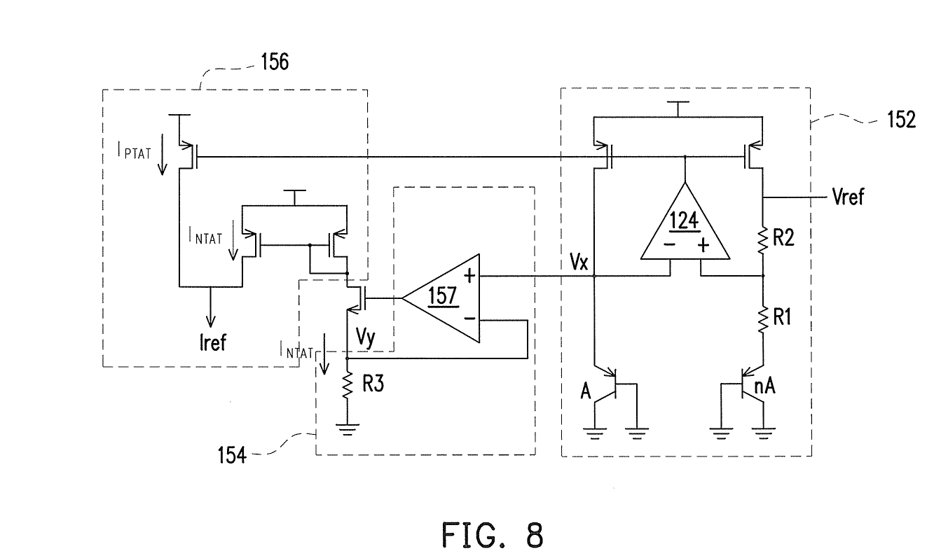

Referring to FIG. 8, the band-gap reference voltage generator of FIG. 3 can also be employed by the present invention for achieving similar objects. As shown in FIG. 8, the positive input terminal (+) of the operation amplifier 157 receives the voltage Vx=V_{BE}, corresponding to the BJT 126, from the band-gap reference voltage generator, while the negative input terminal (−) receives the voltage Vy and the current I_{NTAT} from the output terminal.

It should be noted that the circuits as shown in FIGS. 6 to 8 are embodiments provided for illustrating the spirit of the present invention without restricting the scope of the present invention. In other words, the spirit of the present invention is determined by the blocks of FIG. 5, (i.e., the reference voltage generator 152, the voltage-to-current converter 154, and the adding unit 156). The reference voltage generator 152 adopts a conventional band-gap reference voltage for generating the reference voltage. In addition, the present invention further employs the voltage-to-current converter 154, and the adding unit 156 to fetch two currents corresponding to two voltages. Values of the two currents are adjusted, and then added to obtain the reference current Iref.

The present invention further provides a method for generating a reference voltage and a reference current. The method includes generating a first voltage and a second voltage with a voltage generating circuit. According to a temperature variation, the first voltage and the second voltage have a first direction responsive variation and a second direction responsive variation, respectively. The reference voltage is generated by combining the first voltage and the second voltage. The first voltage is converted for outputting a first current. The first current has a first direction responsive variation according to the temperature variation. A second current corresponding to the second voltage is obtained. The second current has a second direction responsive variation according to the temperature variation. The first current and the second current are added to obtain a reference current. Both of the reference voltage and the reference current are temperature-independent.

In other words, the present invention is made based upon a reference voltage generating circuit, and adaptively converts voltages or currents indirectly generated by the reference voltage generating circuit to obtain the reference current. As such, the present invention eliminates the necessity of employing another reference current generator in addition.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A generator for generating a reference voltage and a reference current, the generator comprising:
a reference voltage generating circuit, for generating a first voltage and a second voltage, and combining the first voltage and the second voltage to generate a reference voltage, wherein, according to a temperature variation, the first voltage and the second voltage have a first direction responsive variation and a second direction responsive variation, respectively;
a voltage-to-current converting circuit, coupled to the reference generating circuit, for outputting a first current according to the first voltage, wherein the first current has the first direction responsive variation according to the temperature variation; and
an adding circuit, coupled to the reference voltage generating circuit and the voltage-to-current converting circuit, for fetching a second current corresponding to the second voltage from the reference voltage generating circuit, and adding the first current to the second current to obtain a reference current,
wherein the second current has the second direction responsive variation according to the temperature variation, and both of the reference voltage and the reference current are temperature-independent.

2. The generator according to claim 1, wherein the voltage-to-current converting circuit comprises a mapping circuit for mappingly inputting the first current into the adding circuit.

3. The generator according to claim 1, wherein the voltage-to-current converting circuit comprises a resistor for converting the first voltage into the first current.

4. The generator according to claim 1, wherein the first direction responsive variation is a negative responsive variation, and the second responsive variation is a positive responsive variation.

5. The generator according to claim 1, wherein the first direction responsive variation is a positive responsive variation, and the second responsive variation is a negative responsive variation.

6. The generator according to claim 1, wherein the reference voltage generating circuit is a band-gap reference voltage generator.

7. The generator according to claim 6, wherein the voltage-to-current converting circuit fetches the first voltage from the band-gap reference voltage generator, and the adding circuit fetches the second current corresponding to the second voltage from the band-gap reference voltage generator.

8. The generator according to claim 1, wherein the reference voltage is a sum of the first voltage and the second voltage.

9. A method for generating a reference voltage and a reference current, the method comprising:
utilizing a voltage generating circuit to generate a first voltage and a second voltage, wherein, according to a temperature variation, the first voltage and the second voltage have a first direction responsive variation and a second direction responsive variation, respectively;
generating a reference voltage according to the first voltage and the second voltage;
converting the first voltage to a first current, wherein the first current has a first direction responsive variation according to the temperature variation;
obtaining a second current corresponding to the second voltage, wherein the second current has a second direction responsive variation according to the temperature variation; and
adding the first current to the second current to obtain a reference current,
wherein both of the reference voltage and the reference current are temperature-independent.

10. The method according to claim 9, wherein the first direction responsive variation is a negative responsive variation, and the second responsive variation is a positive responsive variation.

11. The method according to claim 9, wherein the first direction responsive variation is a positive responsive variation, and the second responsive variation is a negative responsive variation.

12. The method according to claim 9, wherein the reference voltage generating circuit is a band-gap reference voltage generator.

13. The method according to claim 12, wherein the first voltage is fetched from the band-gap reference voltage generator, and the second current corresponding to the second voltage is fetched from the band-gap reference voltage generator.

14. The method according to claim 9, wherein the reference voltage is a sum of the first voltage and the second voltage.
